(19) United States
(12) Patent Application Publication
(10) Pub. No.: US 2010/0247043 A1
(43) Pub. Date: Sep. 30, 2010

(54) OPTICAL MODULE AND WAVELENGTH DIVISION MULTIPLEXING OPTICAL MODULE

(75) Inventors: Toshiki SUGAWARA, Kokubunji (JP); Kazuhiko HOSOMI, Fujisawa (JP); Yasunobu MATSUOKA, Hachioji (JP); Takuma BAN, Kokubunji (JP); Koichiro ADACHI, Musashino (JP); Youngkun LEE, Hachioji (JP); Masahiro AOKI, Kokubunji (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/707,739

(22) Filed: Feb. 18, 2010

(30) Foreign Application Priority Data
Mar. 24, 2009 (JP) 2009-071139

(51) Int. Cl. G02B 6/36

(52) U.S. Cl. 385/93; 385/88

(57) ABSTRACT

An optical module is formed by sticking the optical element mounting substrate and the sealing substrate together, then by sealing the stuck body. The optical mounting substrate includes an optical element on its top surface and it is used to guide electrical signals to its back side through a through-via hole provided in itself. The sealing substrate includes a lens at its back side and a recessed part used to hold an optical fiber at its front side.

### CLAIM OF PRIORITY

The present application claims priority from Japanese patent application JP 2009-071139 filed on Mar. 24, 2009, the content of which is hereby incorporated by reference into this application.

### FIELD OF THE INVENTION

The present invention relates to an optical module, particularly to an optical module to be employed for optical communications to transmit a light with use of an optical fiber respectively.

### BACKGROUND OF THE INVENTION

In recent years, optical communication traffics have been rapidly expanding to exchange large capacity data in the field of information communications. So far, optical fiber networks have been developed in order to meet the requirements of such optical communications in comparatively long distances of more than a few kilometers for trunk, metro, and access systems. And in the near future, optical fibers will also come to be used for signal wirings even in extremely short distances between transmission apparatuses (from a few meters to a few hundred meters) or between devices (from a few centimeters to a few tens of centimeters) to process large capacity data quickly. In addition, now that finer images are required even in the consumer fields such as video gear of video cameras, etc., PCs, mobile phones, etc., fast and large capacity optical signal transmission lines will be required more and more. Along with such a tendency of handing such large capacity information even in the consumer gear, compact and low cost optical modules have been demanded eagerly and urgently.

JP-A-2005-338308 discloses an example of such an optical module. In the JP-A-2005-338308, FIG. 14 shows a configuration of the optical module in which a first conductive guide 9 having a hole 20 of which outside diameter is slightly wider than an optical fiber 1 and narrower than a light receiving element PD17, as well as a second conductive substrate 10 of which external shape is almost the same as the first conductive guide 9 are fastened and the optical fiber 1 is inserted in the hole 20, which is a through-hole provided for the first conductive guide 9 while the optical fiber 1 and the first conductive guide 9 are fastened with solder.

### SUMMARY OF THE INVENTION

FIG. 1 shows an example of the configuration of the optical module we had manufactured on an experimental basis. In the configuration, an optical fiber is connected to a CAN package that includes a laser element. The optical module also includes an optical fiber 100, a ferrule 106, a lens 115, plural packages 102, a laser element 103, a sub-mount 104, a stem 101, plural pins 108, and plural bonding wires 107. Each of the pins 108 is connected to an external device to transmit electric signals into the stem 101. Each of the pins 108 and the sub-mount 104 are connected to each other electrically through a bonding wire 107. The sub-mount 104 is a circuit-provided substrate with excellent heat radiation properties. On this substrate are mounted such optical elements as a laser, a photodiode, etc. so as not to be disposed directly on the subject substrate, thereby improving the characteristics of those optical elements respectively. The laser element 103 is mounted on the sub-mount 104. The electrode of each optical element and the sub-mount electrode that are disposed in a lower portion are connected to each other electrically through a conductive part (electrical connection with use of a bonding wire or by means of flip-chip bonding). The optical signal emitted from the laser element 103 according to an electric signal is condensed by the lens 115 and guided to the fiber 100 through the ferrule 106. Here, the package 102-1 is used to fasten the lens 115 and seal the laser element 103 tightly. This tight sealing can improve the reliability and other properties of the optical elements. The package 102-2 is used to fasten the ferrule 106 connected optically to the fiber 100.

The optical module package has three important functions; 1) transmitting electric signals received from external to the optical element, 2) sealing the optical element tightly to improve the reliability, and 3) realizing optical connection between the optical element and the optical fiber. This configuration, however, needs to achieve cost reduction of the whole package, lower and smaller size, higher airtight mounting indispensably. Furthermore, in order to assure such airtight mounting of the optical elements, each of the optical elements, the lens, and the optical fiber must be aligned to others. And to satisfy this requirement, the number of parts and components, as well as the number manufacturing processes become bottlenecks.

When compared with the configuration on the experimental basis described above, the technique disclosed in the JP-A-2005-338308 is considered to be more improved in the reduction of both cost and size. However, as described above, because the technique forms a through-hole as the hole 20 of the first conductive guide 9, while it can assure a high positioning freedom in the light axis direction, it is difficult to reduce the distance between the optical fiber 1 and the PD 17 passively within a predetermined range with satisfactory reproducibility except when the optical fiber 1 and the PD 17 are put in contact with each other. It is also anxious that the optical fiber 1 passed through the first conductive guide 9 is protruded into a free space between the first conductive guide 9 and the second conductive substrate 10 without using any guide; it might cause problems such as aged deterioration and adverse influence to external forces. Furthermore, because the same material is used to fasten and seal the optical fiber 1 and the first conductive guide 9, an external force comes to be applied to the optical fiber 1, for example, when it is disposed in the subject transmission device even after it is fastened together with the first conductive guide 9. Therefore, even while the optical fiber 1 and the first conductive guide 9 are kept fastened in their positions, the sealing might be lost. And there is still left another large anxiety in the technique disclosed in the JP-A-2005-338308; unless the optical fiber 1 is fit and fastened in position, no durability test can be carried out for the optical module while the optical element is mounted in the sealed space.

Under such circumstances, it is an object of the present invention to, improve the reliability of the object optical module in which an optical element mounting substrate (second substrate) is covered with a sealing substrate (first substrate) having a sealing function and an optical fiber guiding function. It is another object of the present invention to provide a method that simplifies the manufacturing processes for the same.

The present invention will achieve the above objects as follows.

In one aspect of the present invention, the optical module is structured so that an optical element mounting substrate (first substrate) having an optical element on its opposite surface (second surface) and a sealing substrate (second substrate) having a sealing function and an optical fiber guiding function are provided to seal a space between the opposite surface (second surface) of the optical element mounting substrate and the opposite surface (first surface) of the sealing substrate. And the optical element is mounted beforehand on the second surface of the optical element mounting substrate disposed in this sealed space at the side of the sealing substrate. Furthermore, a through-via hole is formed in the optical element mounting substrate and a wiring is passed through this via hole to the back side (first surface) of the optical element mounting substrate. Thus the optical element can be driven with a simple structure. And the sealing substrate is given a recessed part (not a through-hole) on the fourth surface, which is positioned oppositely to the optical element mounting substrate and an optical fiber is fit and fastened in the recessed part for an optical connection between the optical element and the optical fiber.

In this configuration of the optical module, the recessed part on the fourth surface, which is outside the sealing substrate, is assumed as a non-through hole, so that the optical fiber is fit deep in the recessed part with its own weight. This can prevent the bottom of the recessed part and the tip of the optical fiber from damages, thereby the optical element and the optical fiber can be prevented from coming into contact with each other. And any troubles that might occur in the fastening part between the sealing substrate and the optical fiber can affect the sealing. Even when the optical fiber is not fastened, the durable test can be carried out for the optical element in the sealed space. Therefore, defect occurrence can be known earlier, thereby the manufacturing yield can be improved. And because the recessed part for fitting the optical fiber is such deep, the optical distance between the optical element and the optical element can be set properly. The optical connection can also be made easily just with passive core adjustments. Even when highly accurate controlling is required for the optical distance between the optical element and the optical fiber, because the optical distance is almost already finished in such a way, the controlling can be made just with fine adjustments. Although the optical fiber is inserted in the recessed part directly in the above example, the configuration can also be modified so that the ferrule is fit in the optical fiber and furthermore and a sleeve is fit in the recessed part of the sealing substrate.

Furthermore, the following items (1) to (7) can be combined as needed to improve the above configuration of the optical module.

(1) A light receiving part is disposed between an optical element and a sealing substrate and held by the opposite surfaces of the sealing substrate and the optical element mounting substrate so as to reduce the number of parts of the holding part. The light receiving part described above is a passive part that requires no electrical controlling. It can be a condensing lens, for example. This condensing lens should preferably be a low price ball lens when in taking consideration to the holding structure employed between the sealing substrate and the optical element mounting substrate.
(2) If an optical fiber having a curved surface tip (tip ball lens) to be fit/inserted in a recessed part, the optical connection to the optical element is further improved. The lens can be omitted although it depends on the connecting properties.
(3) If the side wall of the bottom surface of the recessed part is a recessed curved surface, the end spherical lens in (2) can be fit more easily.
(4) If the tip of the optical fiber to be fit/inserted into the recessed part has a surface to be assumed as a normal line, which is different from the center axis of the fiber core (an optical fiber having an inclined end surface) and it is fit to the inclined surface provided in the recessed part on the second substrate, the optical fiber can be fit in position easily just by turning the optical fiber fit in the recessed part slightly.
(5) A sealing space that includes an optical element is required to fasten the sealing substrate and the optical element mounting substrate. However, such a space can be omitted by adjusting the thickness of the bottom of the recessed part of the sealing substrate. In this case, a spacer that surrounds the optical element should be provided to generate a likelihood with respect to the positioning accuracy between the sealing substrate and the optical element mounting substrate. If a light receiving part is disposed between the sealing substrate and the optical element mounting substrate, it will be easier to secure a proper height of the sealing space in which the light receiving part is disposed, position the optical element on the optical element mounting substrate, and hold the light receiving part firmly in position. The inside wall of the spacer should preferably be tapered forward for proper positioning of the light receiving part. If this spacer is a separate one, displacement might occur on the optical element mounting substrate. In order to avoid this problem, the spacer should preferably be formed as part of the optical element mounting substrate by etching, for example.
(6) If a first lens is provided on the surface of the sealing substrate at the side of the optical element mounting substrate so as to be used for the optical connection between the optical element and the optical fiber, the optical connection efficiency is more improved. This first lens may be formed by processing the sealing substrate, a separate lens may be adhered to the sealing substrate with transparent resin, or the lens may be formed with the transparent resin itself.
(7) If the optical element is mounted on the surface of the optical element mounting substrate at the side of the sealing substrate by the flip-chip bonding method, both the module size reduction and the band widening by lowering the inductance at the electric connection spots can be achieved at the same time.

In another aspect, the present invention also includes the following structure of the optical module to which the optical fiber is not fit yet. As described above, the optical module is disposed between the optical element mounting substrate and the sealing substrate. At first, the optical module is formed from a large substrate that enables multiple production. Then, a large sealing substrate that enables multiple production and a large optical element mounting substrate that enables multiple production are stuck together, then the stuck body is cut into individual substrates. As a result, the sticking process can be simplified and the durable test can be carried out for the stuck large substrate body, as well as for cut-off plural substrates simultaneously. The mass productivity can thus be much improved.

According to the present invention, therefore, it is possible to improve the reliability of the optical module in which the optical element mounting substrate (second substrate) is covered by the sealing substrate (first substrate) having a sealing function and an optical fiber guiding function, as well as to simplify the manufacturing method of the optical module.

### BRIEF DESCRIPTION OF THE DRAWINGS

FIG. 1 is a cross sectional view of a CAN package of a conventional horizontal resonator end face light emitting laser element;

FIG. 2A is a cross sectional view of an optical module in the first embodiment of the present invention;

FIG. 2B is a wafer scale view and an expanded view of the optical module shown in FIG. 2A with respect to how to manufacture the structure of the optical module in the first embodiment of the present invention;

FIG. 3 is a cross sectional view of an optical module in the second embodiment of the present invention;

FIG. 4 is a cross sectional view of an optical module in the third embodiment of the present invention;

FIG. 5 is a cross sectional view of an optical module in the fourth embodiment of the present invention;

FIG. 6 is a cross sectional view of an optical module in the fifth embodiment of the present invention;

FIG. 7 is a cross sectional view of an optical module in the sixth embodiment of the present invention;

FIG. 8 is a cross sectional view of an optical module mounting substrate of an optical module in the seventh embodiment of the present invention;

FIG. 9 is a cross sectional view of an optical module mounting substrate of an optical module in the eighth embodiment of the present invention;

FIG. 10A is a cross sectional view of an optical module in the ninth embodiment of the present invention;

FIG. 10B is a wafer scale view and an expanded view of the optical module shown in FIG. 10A with respect to how to manufacture the structure of the optical module in the ninth embodiment of the present invention;

FIG. 11 is a cross sectional view of an optical element mounting substrate of an optical module in the tenth embodiment of the present invention;

FIG. 12 is a cross sectional view of an optical element mounting substrate of an optical module in the eleventh embodiment of the present invention;

FIG. 13A is a cross sectional view of a lens accumulated horizontal resonator vertical emission type laser element employed for the optical module of the present invention in an embodiment of the present invention;

FIG. 13B is a top view of the lens accumulated horizontal resonator vertical emission type laser element;

FIG. 14 A is a cross sectional view of a lens accumulated photodiode employed for the optical module of the present invention in an embodiment of the present invention;

FIG. 14B is a top view of the lens accumulated photodiode;

FIG. 15 is a cross sectional view of an optical module in the twelfth embodiment of the present invention;

FIG. 16 is a cross sectional view of an optical module in the thirteenth embodiment of the present invention;

FIG. 17 is a cross sectional view of an optical module in the fourteenth embodiment of the present invention;

FIG. 18 is a cross sectional view of an optical module in the fifteenth embodiment of the present invention;

FIG. 19 is a cross sectional view of an optical module in the sixteenth embodiment of the present invention;

FIG. 20 is a cross sectional view of an optical module in the seventeenth embodiment of the present invention;

FIG. 21 is a diagram for showing the optical disposition of the optical module configured as shown in FIGS. 15 through 20 when there are an even number of photodiodes (or laser elements) are provided;

FIG. 22 is a diagram for showing the optical disposition of the optical module configured as shown in FIGS. 15 through 20 when plural photodiodes (or laser elements) are provided equivalently;

FIG. 23 is a cross sectional view of an optical module in the seventeenth embodiment of the present invention;

FIG. 24 is a cross sectional view of an optical module in the eighteenth embodiment of the present invention; and

FIG. 25 is a diagram for describing a receptacle employed for the optical module of the present invention in an embodiment of the present invention.

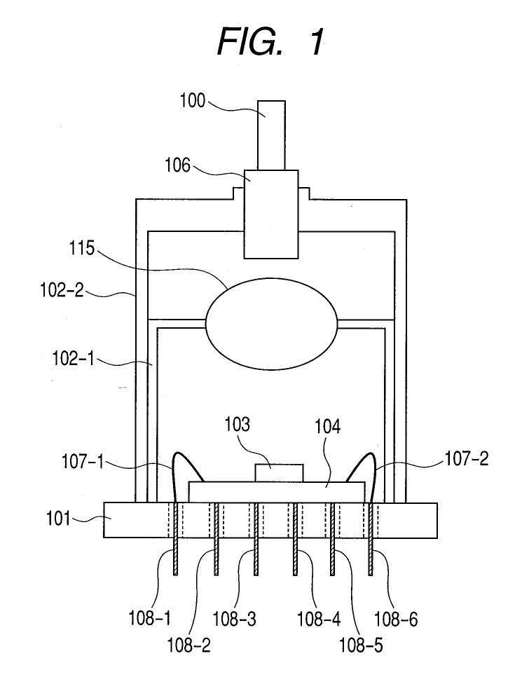

### DETAILED DESCRIPTION OF THE PREFERRED EMBODIMENTS

Hereunder, there will be described the preferred embodiments of the present invention in detail with reference to the accompanying drawings.

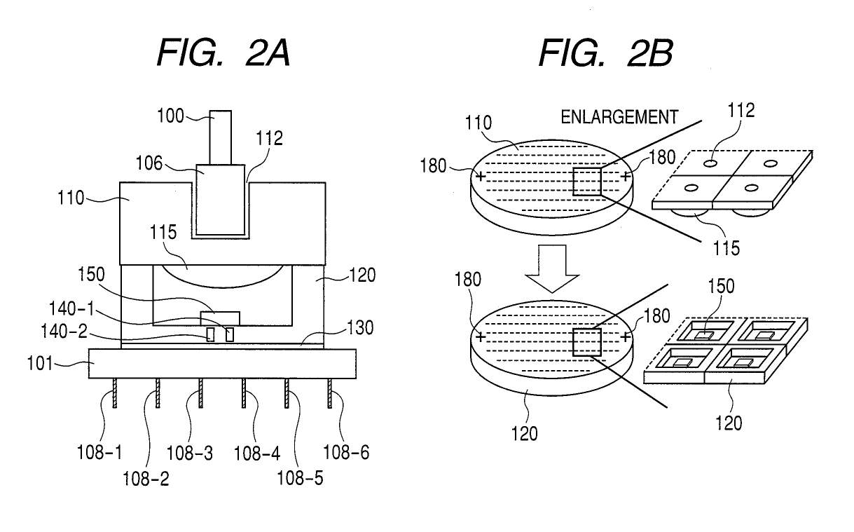

FIG. 2A is a cross sectional view of an optical module in the first embodiment of the present invention. In this first embodiment, the optical module includes an optical module 100, a ferrule 106, a fiber fitting recessed part 112, a sealing substrate 110, a lens 115, an optical element (a laser element in this embodiment, but it may be a photodiode PD) 150, through-via holes 140 (140-1 and 140-2), an optical element mounting substrate 120, an electric wiring 130, a stem 101, and pins (108-1 to 108-6).

One end of each of the pins 108 is connected electrically to an external device to transmit electrical signals into the stem 101. The other end of each of the pins 108 is connected electrically to one of the through-via holes 140 through the electric wiring 130. In this first embodiment, the flip-chip bonding method is used to connect the optical element 150 to an electrode; both are connected electrically to each other through a through-via hole 140. This flip-chip bonding method can reduce the optical module in size, as well as enables band-widening when the inductance is lowered at electric connection points respectively. In this case, a bonding wire can also be used for the connection between the through-via hole 140 and the optical element 150.

If this optical element is a laser element, the light signal output from the optical element 150 according to an electric signal is condensed by the lens 115 and guided to the optical fiber 100 through the sealing substrate 110 and the ferrule 106 fit in the fiber fitting recessed part 112.

The sealing substrate 110 is made of glass, which absorbs almost no light at the employed wavelength and it is almost transparent optically. A semiconductor material such as silicon can also be used to form the sealing substrate 110. There is also another method for forming the sealing substrate 110 as follows, for example; at first, holes are made in such a non-transparent material as metal and such a semiconductor material as silicon is stuck to those holes to transmit the light only at necessary spots.

If glass is used, the lens 115 can be formed in the sealing substrate 110 by press-fitting the glass with use of a metal mold. Furthermore, a separately formed lens 115 can be adhered to the sealing substrate 110 with light-transmission resin and the lens 115 itself can be formed with light-transmission resin. If a semiconductor material is used to form the sealing substrate 110, the lens 115 can be formed in the sealing substrate 110 by etching. As described above, because the lens 115 can be positioned precisely and the optical element 150 can be sealed tightly with use of the sealing substrate 110, the efficiency of the optical connection between the optical element 150 and the optical fiber 100 can be improved.

And the sealing substrate 110 is provided with a fiber fitting recessed part 112, in which the ferrule 106 can be fastened accurately. If the sealing substrate 110 is made of glass, the fiber fitting recessed part 112 provided for the sealing substrate 110 can be formed by press-fitting with use of a metal mold just like the lens 115. If the sealing substrate 110 is made of a semiconductor material, the fiber fitting recessed part 112 can be formed by etching, as well as by cutting such as drilling.

FIG. 2B is a wafer scale view and an expanded view of how to form a structure of the optical module in this first embodiment of the present invention. At, first, a hole, as well as a lens 115 are formed inside the surface of the sealing substrate 110. The hole is assumed as the fiber fitting recessed part 112. If an AR (Anti-Reflection) film, a wavelength selection filter, etc. are to be coated, evaporation or sputtering is employed for the coating. At this time, alignment marks 180 are formed outside the surface of the sealing substrate 110 with a metal or dielectric film, or in a direct treatment process for the substrate 115.

Next, wet etching, cutting, or the like is applied inside the surface of the optical element mounting substrate 120 to form plural grooves and the alignment marks 180, then an optical element 150 is put on each of those grooves, thereby completing forming the optical element mounting substrate 120 at a wafer level precision.

Finally, as shown with an arrow, the sealing substrate 110 is positioned with reference to the alignment marks 180 and stuck on the optical element mounting substrate 120. Although the sticking method is not limited especially here, it should be any of soldering in ordinary electric mounting or solderless wafer bonding. After this, the stuck substrate 110 is cut into chips by dicing, for example. In such a way, a large substrate from which multiple chips can be produced is used to form the structure of the optical module to be put between the optical element mounting substrate 120 and the sealing substrate 110. Here, the optical module is that before the optical fiber is fit therein. Then, such a large sealing substrate that enables multi-chip production and a large optical element mounting substrate that enables multi-chip production are stuck together, then the stuck body is cut into multiple chips, thereby the sticking process can be simplified and the durability test and other inspections come to be carried out simultaneously for plural chips. Thus the method can improve the mass productivity significantly.

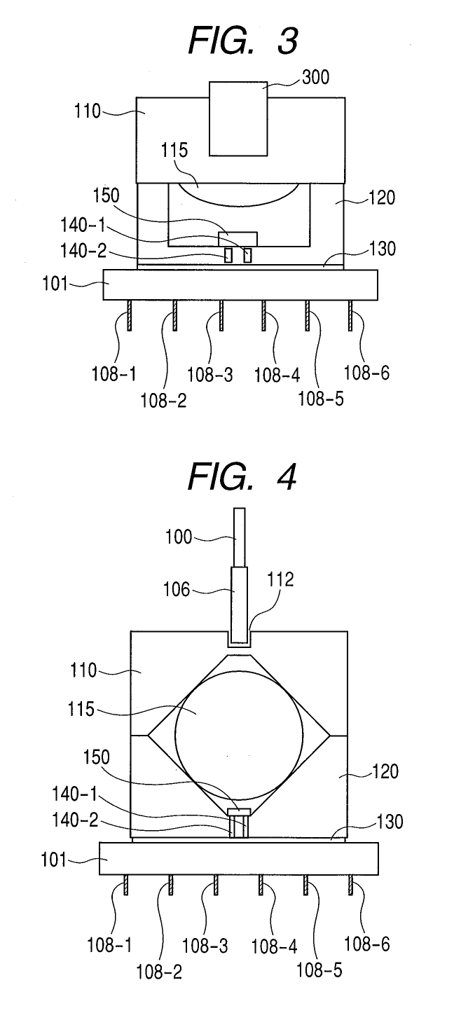

FIG. 3 is a cross sectional view of an optical module in the second embodiment of the present invention. This structure is that of the optical modules referred to as receptacle ones. In case of this receptacle type optical module, optical fibers having connectors respectively can be attached to or removed from the optical module. The optical module shown in FIG. 3 is provided with a part 300 referred to as a receptacle, which is fit in the fiber fitting recessed part 112 of the sealing substrate 110 shown in FIG. 2. FIG. 25 is a cross sectional view of the structure of the receptacle. The receptacle consists of a holder part 310, a sleeve 320, and an optical connector 330. The holder part 310 is made of metal or the like. The sleeve 320 holds the optical connector 330. The optical connector 330 consists of a fiber stub and a glass block. The sleeve 320 enables the ferrule 106 and the optical connector 330 to be aligned to each other precisely. With this sleeve 320, optical signals can be exchanged between the optical module and each optical fiber efficiently.

FIG. 4 is a cross sectional view of an optical module in the third embodiment of the present invention. In this configuration of the optical module, an external lens is used as the lens 115. The groove of the optical element mounting substrate 120 is formed by etching so as to be tapered forward. This means that the spacer is formed outside the groove. This spacer can also be formed as a separate part. In this case, because the spacer might be displaced on the optical element mounting substrate, the spacer should preferably be formed as part of the optical element mounting substrate by etching, for example. The lens 115 is disposed in this groove. The inside wall of the spacer (groove) should preferably be tapered forward so as to make it easier to position the light receiving part represented by this lens 115. The lens 115 should preferably be a spherical ball lens to reduce the manufacturing cost. Because the lens 115 is spherical and the spacer is tapered forward, the lens 115 can be fit easily in the groove of the optical element mounting substrate 120. After this, when the sealing substrate 110 is to be stuck on the optical element mounting substrate 120, the lens 115 is held between the facing surfaces of the sealing substrate and the optical element mounting substrate 120, thereby reducing the number of holding parts. In such a way, this embodiment makes it easier to realize sealing, as well as fastening the lens accurately.

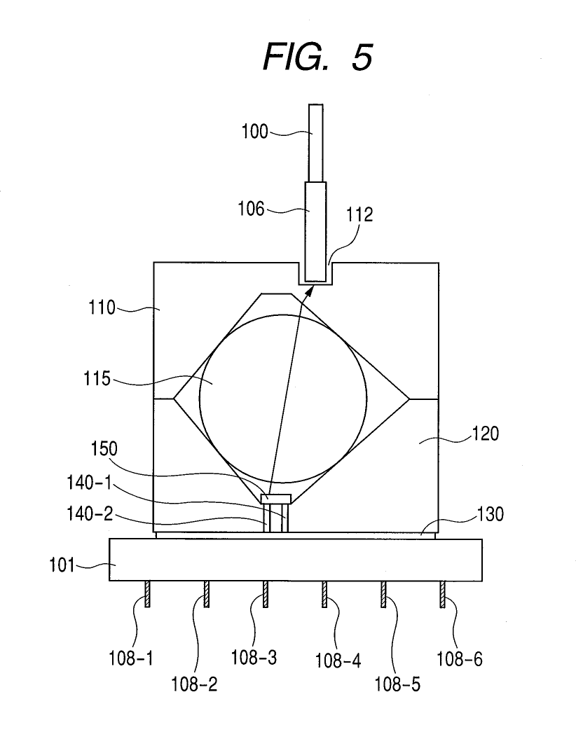

FIG. 5 is a cross sectional view of an optical module in the fourth embodiment of the present invention. In this configuration, measures are taken for antireflection for the optical element and in the optical module. If there is any light reflection in the optical module, the light emitted from the optical element comes to return directly to the optical element, thereby causing unstable operations. For example, AR coating is applied to the ferrule 106 to suppress the reflection, thereby weakening the reflected light or incline the spot to which the light enters from the ferrule 106. Due to these measures, the light emitted from the optical element is reflected obliquely, thereby the reflected light does not return directly to the optical element. In the configuration shown in FIG. 5, in order not to return the reflected light to the optical element more effectively, the lens 115 and the ferrule 106 are disposed so as to be shifted from the optical element, not above the optical element. With this shifting, the light emitted from the optical element 150 comes to go obliquely when passing through the lens 115, the sealing substrate 110, the fiber fitting recessed part 112, and the ferrule 106, thereby almost no light returns to the optical element.

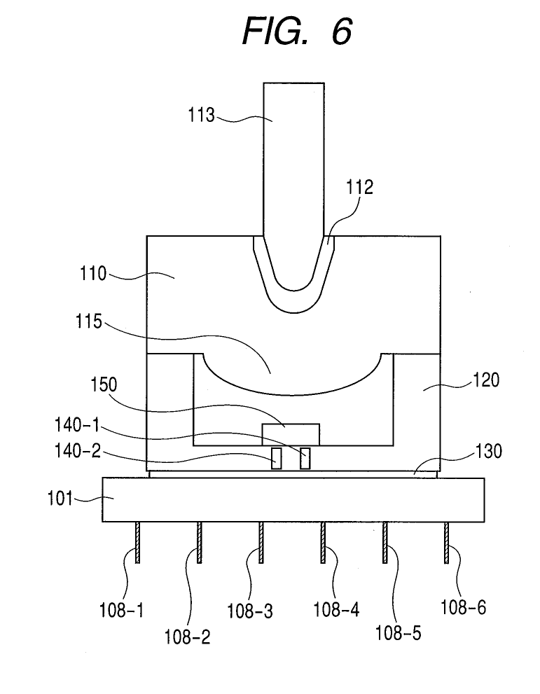

FIG. 6 is a cross sectional view of an optical module in the fifth embodiment of the present invention. Here, the optical fiber is an end spherical fiber 113. The end spherical fiber 113 means an optical fiber of which tip is processed like a spherically carved face so as to improve the efficiency of the connection to the object optical element. In the example shown in FIG. 6, the end spherical fiber 113 is tapered forward as a sharper tip. The bottom of the fiber fitting recessed part 112 provided for the sealing substrate 110 is curved in accordance with the shape of the end spherical fiber. Consequently, the optical fiber 100 and the spherical lens are united into one, thereby the ferrule 106 can be omitted. Thus the optical module can further be reduced in size.

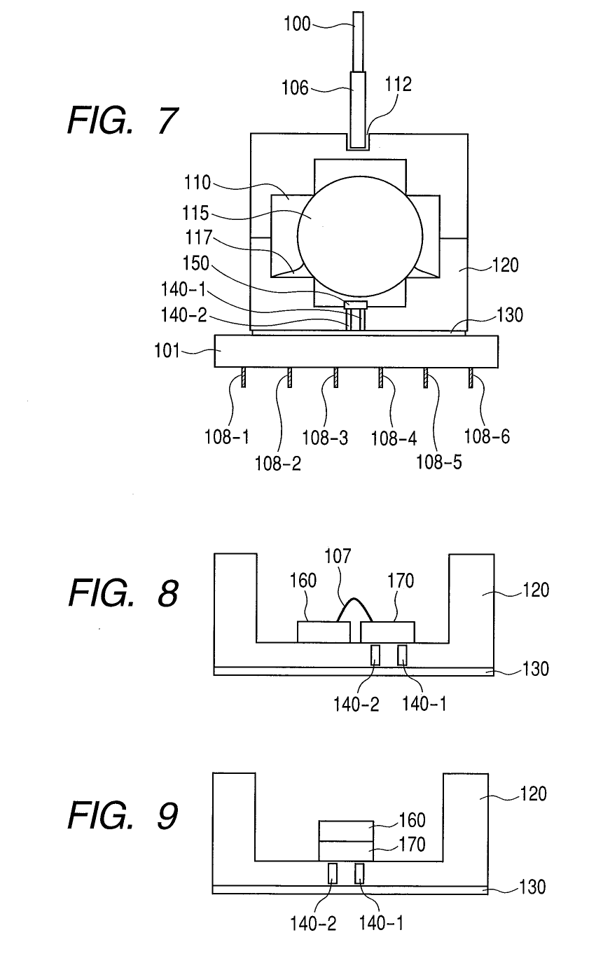

FIG. 7 is a cross sectional view of an optical module in the sixth embodiment of the present invention. In FIG. 7, the groove of the optical element mounting substrate 120 is shaped like a column, thereby this optical module can be sealed only with the optical element mounting substrate 120 and the lens 115. Here, it is also possible to use ultraviolet ray-curable resin 117 to fasten the lens 115.

FIG. 8 is a cross sectional view of an optical element mounting substrate of an optical module in the seventh embodiment of the present invention. The optical module in this seventh embodiment includes an optical element (photodiode) 160, a transimpedance amplifier 170, a bonding wire 107, through-via holes 140, an optical element mounting substrate 120, and an electrical wiring 130. In this example, the optical element 160 is connected electrically to the trans-impedance amplifier 170 through the bonding wire 107, and further to external through the through-via holes 140 to take out electrical signals. The bonding wire can also be used for the connection between each of the through-via holes 140 and the transimpedance amplifier 170. The light transmitted from the fiber 100 to the fiber fitting recessed part 112, the sealing substrate 110, and the lens 115 is received by the optical element 160 and converted to an electric signal (current change). This electric signal is amplified by the transimpedance amplifier 170 so as to be converted from a current change to a voltage change. This electrical signal is transmitted to the through-via holes 140, the electrical wiring 130, and the pin 108 respectively, then output to the object external device.

FIG. 9 is a cross sectional view of an optical element mounting substrate of an optical module in the eighth embodiment of the present invention. In this configuration, a flip-chip is used to mount the optical element (photodiode) 160 and the transimpedance amplifier 170.

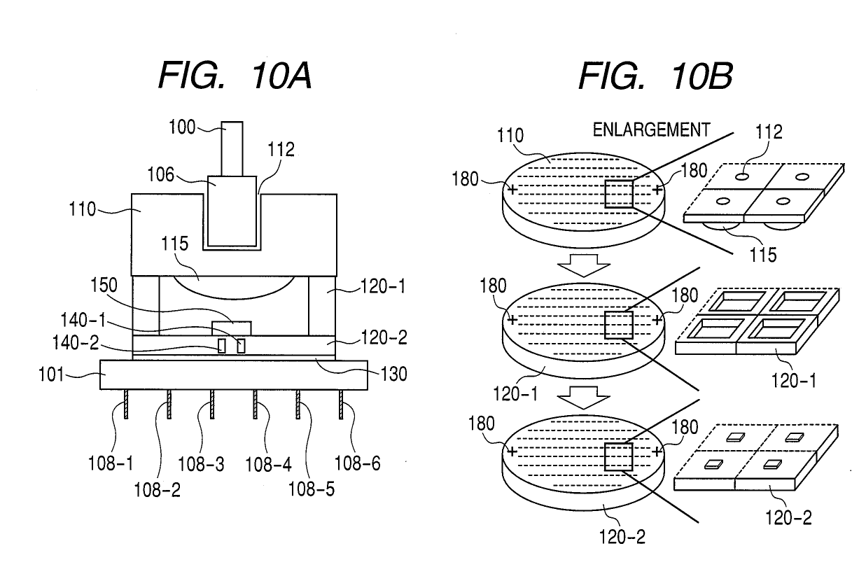

FIG. 10A is a cross sectional view of an optical module in the ninth embodiment of the present invention. FIG. 10B shows a wafer scale view and an expanded view of the optical module for describing how to manufacture the structure of the optical module in this ninth embodiment of the present invention. When compared with the method shown in FIG. 2, this method forms the structure by sticking two optical element mounting substrates 120 together. For example, if a pair of vacuum tweezers is used to mount an optical element in a groove, the groove must be widened enough so that the pair of tweezers can be put in it to absorb the optical element. Therefore, the module size might be limited due to the restriction of the subject mounting device. The configuration of the optical element shown in FIG. 10 can avoid this problem, although the number of sticking times increases. The optical element can thus be mounted without any restriction from the mounting device, thereby the optical module can be reduced more in size.

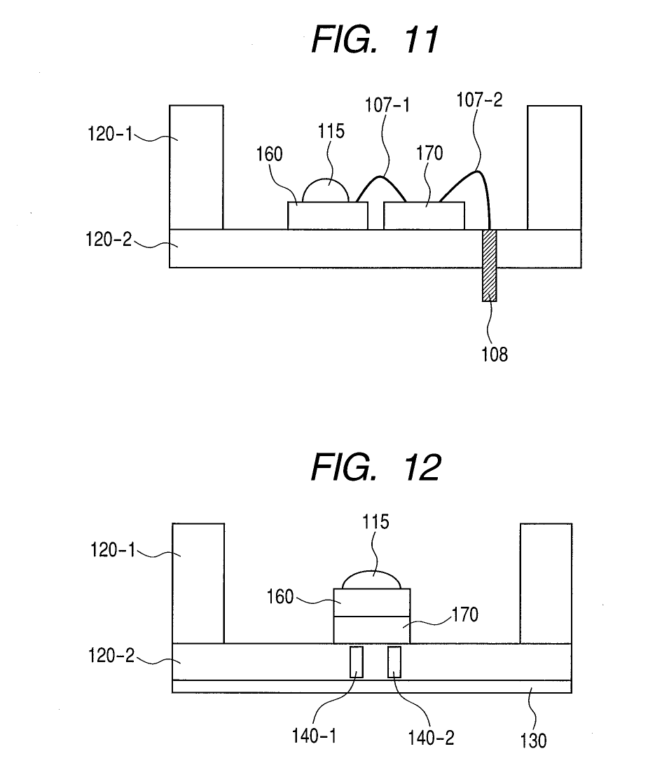

FIG. 11 is a cross sectional view of an optical element mounting substrate of an optical module in the tenth embodiment of the present invention. In this configuration, the optical module includes a lens 115, an optical element (photodiode) 160, a transimpedance amplifier 170, bonding wires 107, bonding wires 107, a pin 108, optical element mounting substrates 120, and an electrical wiring 130. In the above examples, the lens 115 is built in the sealing substrate 110. However, the lens 115 can also be accumulated on the optical element 160. In this case, the lens may or may not be provided for the sealing substrate 110. In this configuration, the optical element is connected electrically to the transimpedance amplifier 170 through a bonding wire 107-1 and further to external electrically through the pin 108 so as to take out electric signals to be output to the object external device. The bonding wire 107-2 is used for the connection between the pin 108 and the transimpedance amplifier 170. The light transmitted from the fiber 100 to the ferrule 106, the fiber fitting recessed part 112, the sealing substrate 110, and the lens 115 is received by the optical element 160 and converted to an electric signal there, then amplified by the transimpedance amplifier 170. This amplified electric signal is output to the object external device through the pin 108.

FIG. 12 is a cross sectional view of an optical element mounting substrate of an optical module in the eighth embodiment of the present invention. Unlike the configuration shown in FIG. 8, a flip-chip is used to mount the optical element (photodiode) 160 and the trans-impedance amplifier 170 on the substrate in this configuration.

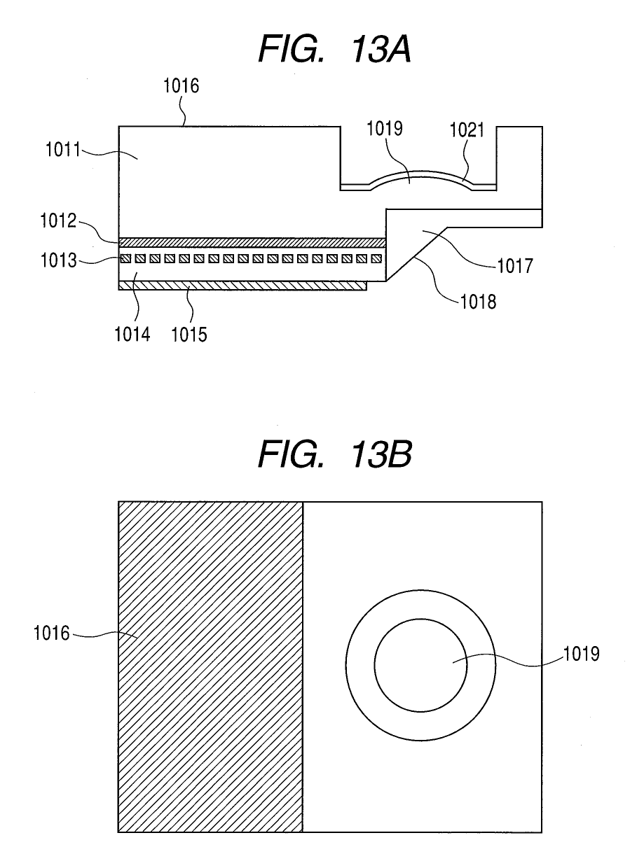

Next, there will be described how to form an optical element preferred to the optical module of the present invention. FIG. 13A is a cross sectional view of a lens accumulated horizontal resonator vertical emission laser element to be employed for the optical module of the present invention and FIG. 13B is a top view of the laser element. FIG. 13A is a cross sectional view of the side of the laser element, which is horizontal to the resonator of the laser element and FIG. 13B is the light emission side of the laser element. The horizontal resonator vertical emission laser is configured so that an active layer 1012 is deposited and grown on an n-type semiconductor substrate 1011, then a grating layer 1013 is formed thereon, and furthermore a p-type clad layer 1014 is deposited thereon. An n-dope InP is used for the n-type semiconductor substrate, an InGaAlAs strained quantum well structure is used for the active layer 1012, GaInAsP or the like is used for the rating layer, and p-dope InP is used for the p-type clad layer. The laser element used here includes a reflection mirror 1018 formed by etching a semiconductor buried layer 1017. At this time, the semiconductor material that is the same as that of the semi-insulating Fe dope InP and the p-type clad layer may be used for the semiconductor buried layer 1017.

The accumulated lens 1019 is formed by etching the n-type semiconductor substrate 1011. Furthermore, a non-reflection coating 1021 is applied on the surface of the lens 1019. The coating 1021 uses, for example, an alumina thin film.

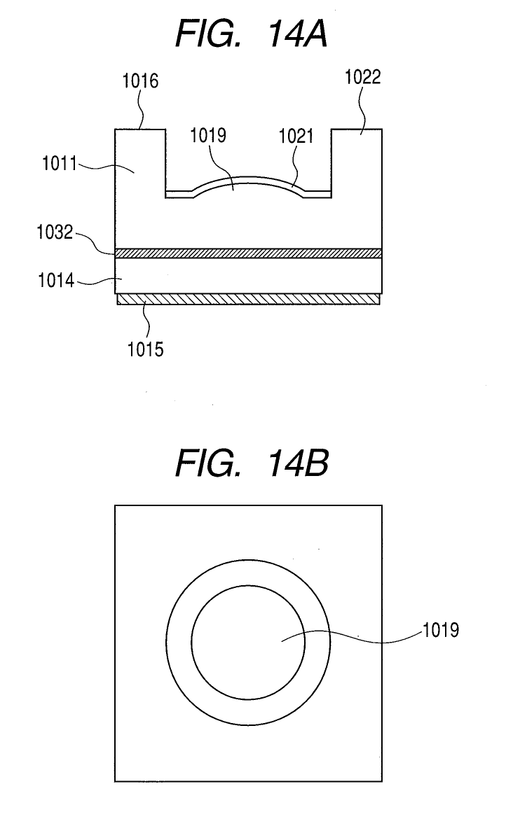

FIG. 14A is a cross sectional view of a lens accumulated photodiode to be used for the optical module of the present invention and FIG. 14B is a top view of the photodiode. This lens accumulated photodiode is formed by depositing an absorbing layer 1032 on the n-type semiconductor substrate 1011, then by depositing the p-type clad layer 1014 thereon. The n-dope InP is used for the n-type semiconductor substrate and the InGaAlSa or the like is used for the absorbing layer 1032. The accumulated lens 1019 is formed by etching the n-type semiconductor substrate 1011. Furthermore, a non-reflection coating 1021 is applied on the surface of the lens 1019. The coating 1021 uses, for example, an alumina thin film.

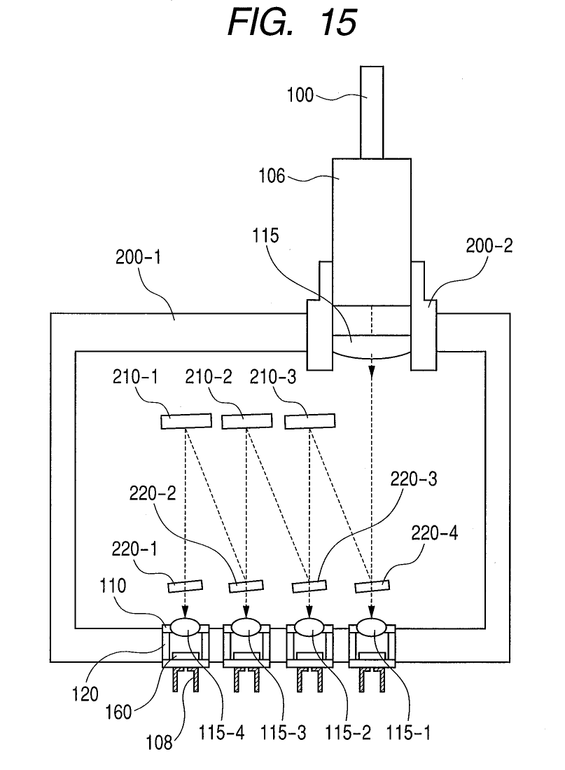

Next, there will be described how an optical module uses plural optical elements of the present invention. FIG. 15 is a cross sectional view of an optical module in the twelfth embodiment of the present invention. The optical module in this twelfth embodiment is packaged. The package includes an optical fiber 100, a ferrule 106, a package 200 (consisting of two pieces 200-1 and 200-2), three mirrors 210 (210-1 to 210-3), and four wavelength selection filters 220 (220-1 to 220-4), as well as the above described optical element. (This optical module also includes a sealing substrate 110, optical element mounting substrates 120, and optical elements 160. The sealing substrate 110 has openings formed toward the wavelength selection filters 220 and lenses 115 (115-1 to 115-4) are fit in those openings.) However, the sealing substrate 110 has no fiber fitting recessed part used to fit the optical fiber 100 and the ferrule 160.

In the package 200 are fastened the ferrule 106, the lens 115, the mirrors 210, the filters 220, and the optical module. The optical signal guided from the optical fiber 100 consists of plural different wavelengths that are multiplexed. This wavelength-multiplexed signal is output from the ferrule 106 and reformed by the lens 115 so as to have the state of an almost collimated light. The light is then transmitted to the wavelength selection filter 220-4, the mirror 210-3, the wavelength selection filter 220-3, the mirror 210-2, the wavelength selection filter 220-2, the mirror 210-1, and the wavelength selection filter 220-1. Each of the wavelength selection filters 220 transmits only one of wavelength-multiplexed signals and reflects all other lights having other wavelengths. The filters 220-4, 220-3, 220-2, and 220-1 separate wavelengths from the light respectively, then the light is condensed by the lenses 115-1 to 115-4 of the optical module and the condensed light is inputted to the optical element 160. In such a way, the present invention can realize a compact wavelength division multiplexing optical module.

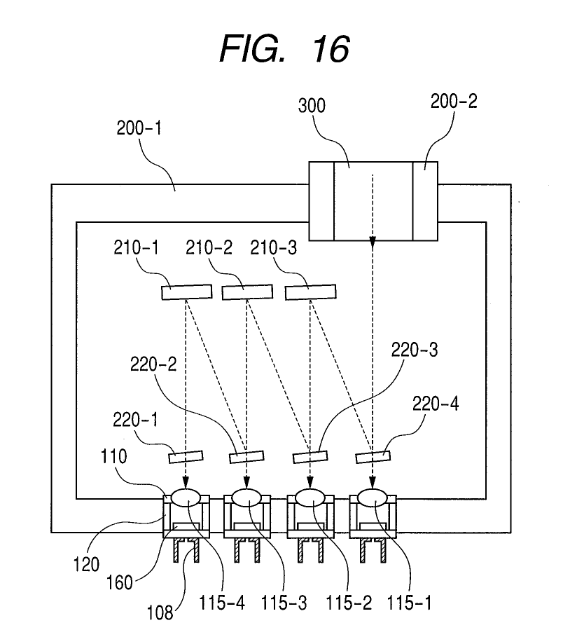

FIG. 16 is a cross sectional view of an optical module in the thirteenth embodiment of the present invention. In this embodiment, a receptacle 300 is added to the configuration of the optical module to realize a receptacle type optical module. In case of this receptacle type optical module, the input direction of the light signal and the output direction of the electric signal from the pin 108 are the same. If this optical module is employed for a receptacle type optical transceiver, etc., the transceiver can be reduced in size effectively. This is because the receptacle part can be used commonly between the optical module and the optical transceiver.

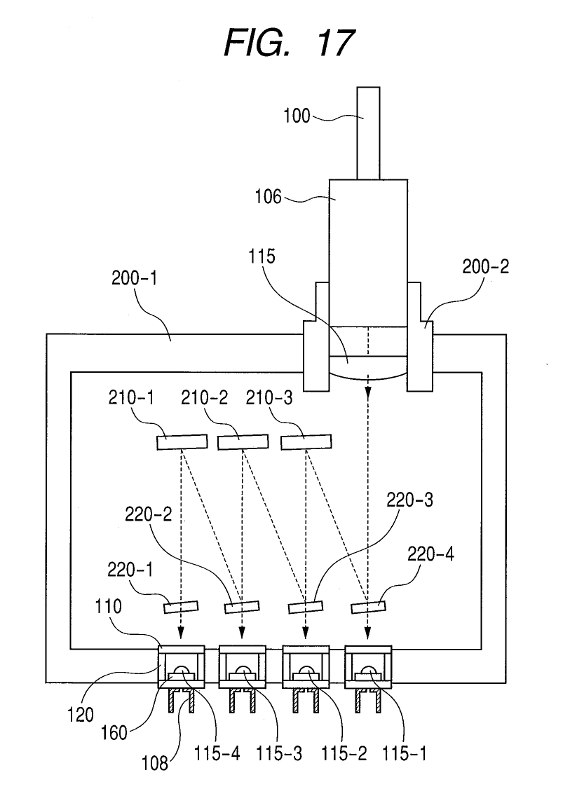

FIG. 17 is a cross sectional view of an optical module in the fourteenth embodiment of the present invention. The optical module in this fourteenth embodiment is packaged and the package includes an optical fiber 100, a ferrule 106, lenses 115, a package 200 (consisting of 200-1 and 2002), mirrors 210, filters 220, and an above-described optical element. (The optical module consists of the sealing substrate 110, the optical element mounting substrate 120, the optical element 160, etc.). The optical module shown here is the same in configuration as that shown in FIG. 11. The lenses 115 are accumulated on the optical element 160.

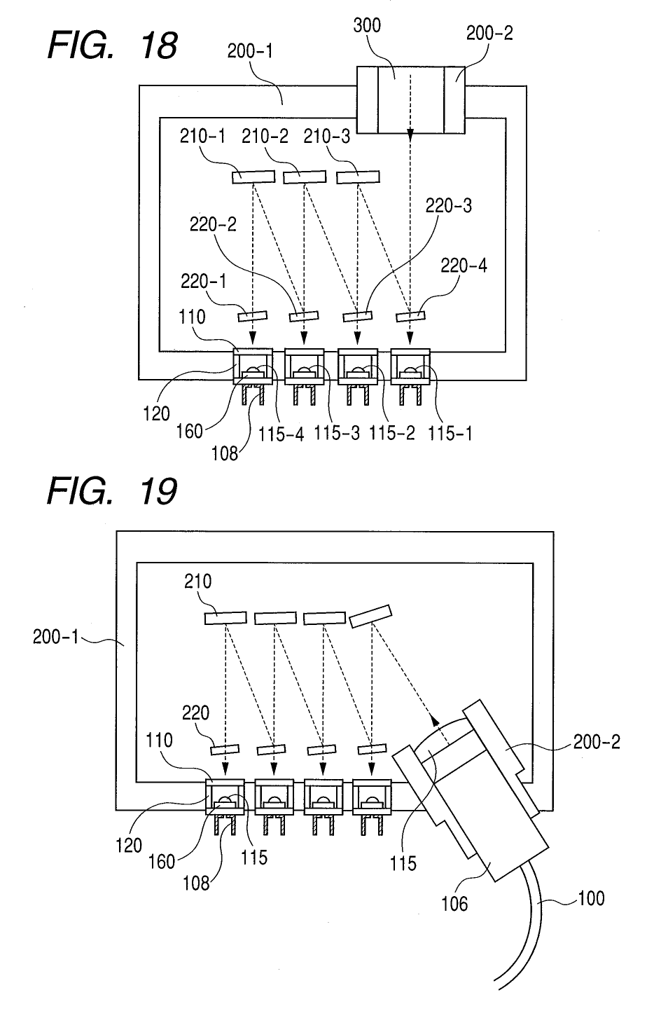

FIG. 18 is a cross sectional view of an optical module in the fifteenth embodiment of the present invention. In this configuration, a receptacle 300 is added to the configuration shown in FIG. 17 to realize a receptacle type optical module. As described above, in case of a receptacle type optical module like this, the input direction of the optical signal and the output direction of the electric signal from the pin 108 of the optical module are the same. If this optical module is employed for an optical transceiver or the like, the object optical transceiver can be reduced in size effectively.

FIG. 19 is a cross sectional view of an optical module in the sixteenth embodiment of the present invention. In this example, a mirror 210 is added to the configuration shown in FIG. 17 to assume the same direction for the output from the optical fiber 100 and for the output of electric signals from the pin 108. If this configuration is employed for a receptacle type optical transceiver, the output from the fiber 100 cannot be assumed as the output of the optical transceiver directly. Thus another receptacle is provided for the optical transceiver and the object optical fiber must be connected to the receptacle to make both of the outputs the same. In this case, a space is required to process the surplus length of the optical fiber. In this example, such an electronic device as a logic circuit is connected to the tip of the pin 108. For example, if such a space for processing the surplus length of the optical fiber is provided above the electronic device, the part can be housed in the subject optical transceiver without requiring any additional area.

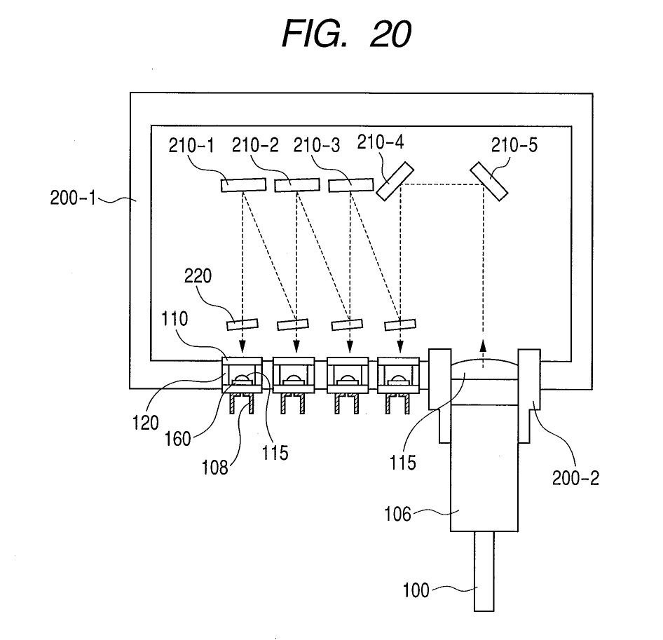

FIG. 20 is a cross sectional view of an optical module in the seventeenth embodiment of the present invention. In this example, another mirror 210 is added to the configuration shown in FIG. 19 so that the exit of the optical fiber becomes almost vertically to the package and almost in parallel to the output direction of the electric signal from the pin 108. This structure is effective to lay the optical fiber obliquely and accurately that might otherwise be difficult due to the restriction of the assembly machine.

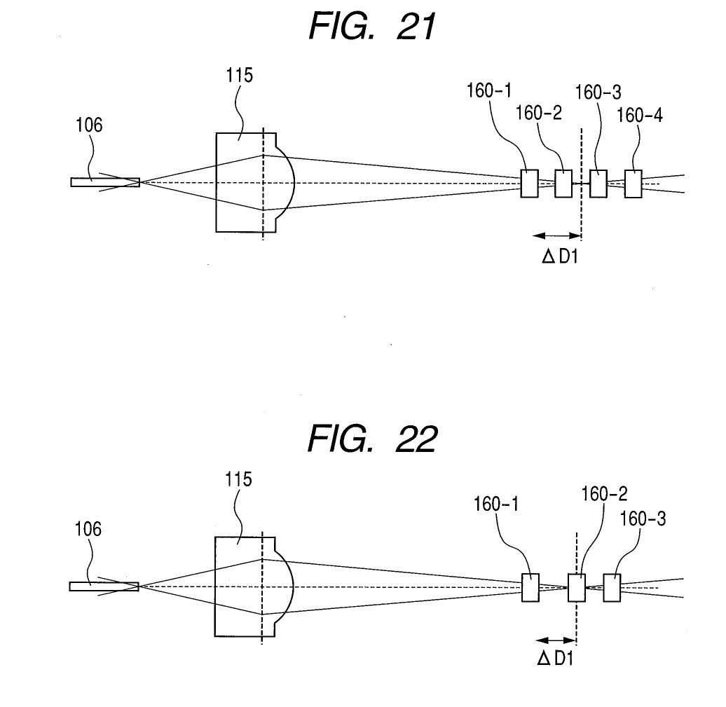

Generally, in order to speed up the operation of a light receiving element, it is required to minimize the light receiving area. In the wavelength division multiplexing optical module of the present invention, therefore, the lens 115 is used to generate an almost collimated beam and another lens set near the optical element is used to condense the collimated beam so as to be received by the optical element. This method can satisfy the above requirement of the light receiving area reduction surely, but the number of parts increases, since an extra external lens is added to each optical element. In order to solve this problem, there is proposed another method, which uses the lens 115 to condense the light once, then an optical element is disposed around the focal point. FIGS. 21 and 22 show optical systems that are equivalent. In this case, the ΔD is minimized with respect to each optical element 160, thereby realizing an optical system that is not to be restricted by the light receiving diameter. If there are provided an even number of optical elements, the optical system shown in FIG. 21 can be employed and if there are provided an odd number of optical elements, the optical system shown in FIG. 22 can be employed to reduce the number of parts in any of the optical modules in the configurations shown in FIGS. 15 through 20.

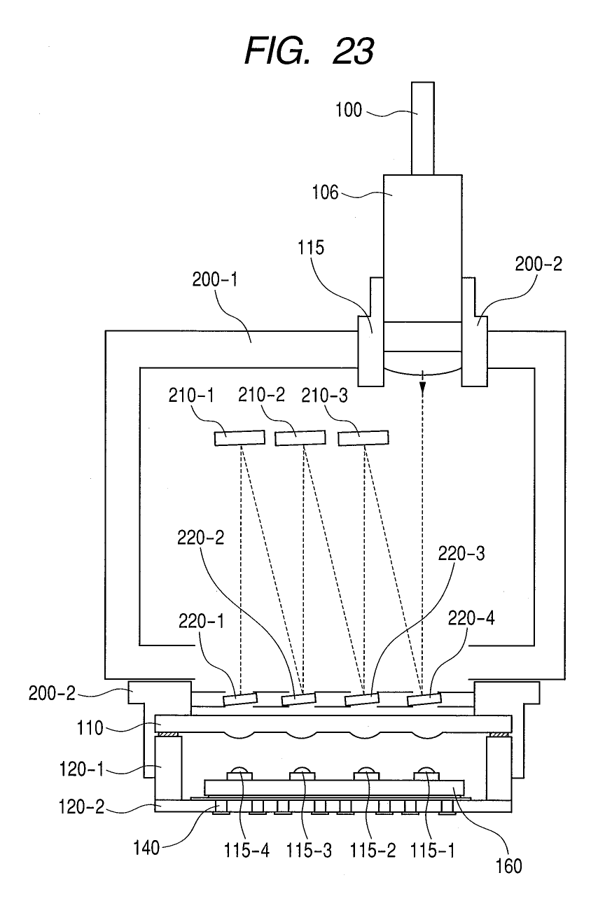

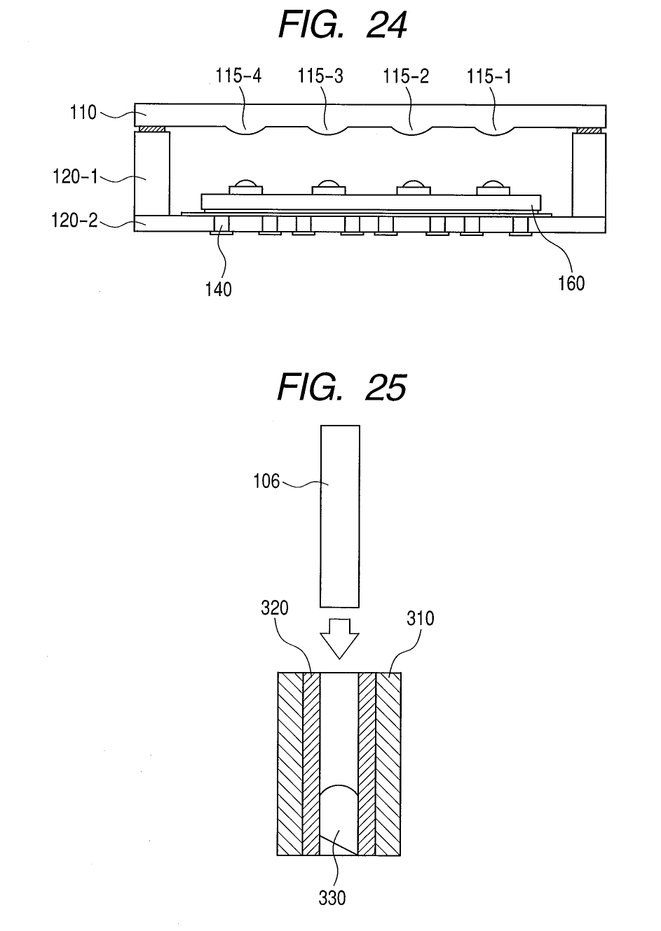

FIG. 23 is a cross sectional view of an optical module in the seventeenth embodiment of the present invention. In this example, the optical elements 160 are arrayed and packaged. The lenses 115 are also arrayed. FIG. 24 shows a minimum configuration of the optical module to be sealed.

As described, according to the present invention, therefore, it is possible to provide an optical module capable of reducing the number of parts and components, as well as the number of mounting processes to realize a compact size and a high yield and easier connection to an object optical fiber. It is also possible to provide a method for manufacturing the optical module. Particularly, it is possible to provide an optical module to be used as a terminal for wavelength division multiplexing optical communications and one core two-way optical communications enabling a light having plural different wavelengths to be transmitted through one optical fiber with low loss optical properties and high reliability, as well as a manufacturing method for the same.

What is claimed is:

1. An optical module comprising a first substrate, an optical element, a second substrate having light transmission properties, and an optical fiber, which are disposed side by side sequentially in itself,
wherein the first substrate includes a second surface facing the second substrate and a first surface positioned oppositely to the first surface;
wherein the second substrate includes a third surface facing the first substrate and a fourth surface positioned oppositely to the first surface;
wherein the second substrate is configured so as to supply a power to the optical element through a wiring connected to the optical element and through a through-via hole provided between the first and second surfaces;
wherein the fourth surface includes a recessed part in which the optical fiber is fit; and
wherein the first and second substrates are fastened to each other at a position where the optical fiber and the optical element are connected to each other optically while a sealing space is provided between the first and second substrates.

2. The optical module according to claim 1,
wherein a light receiving part is provided between the optical element and the second substrate; and
wherein the light receiving part is held by the second surface of the first substrate and by the third surface of the second substrate.

3. The optical module according to claim 2,
wherein the light receiving part is a ball lens.

4. The optical module according to claim 1,
wherein the optical fiber fit in the recessed part has a tip shaped as a convex surface.

5. The optical module according to claim 4,
wherein the side wall of the bottom surface of the recessed part is shaped as a concave curved surface.

6. The optical module according to claim 1,
wherein the optical fiber fit in the recessed part has a tip having an inclined surface, which does not assume a light axis as a normal line.

7. The optical module according to claim 6,
wherein the bottom surface of the recessed part is inclined.

8. The optical module according to claim 1,
wherein a spacer enclosing the optical element is provided between the first and second substrates.

9. The optical module according to claim 8,
wherein the inside wall of the spacer is tapered forward.

10. The optical module according to claim 8,
wherein the spacer is formed with part of the first substrate.

11. The optical module according to claim 10,
wherein the inside wall of the spacer is tapered forward.

12. The optical module according to claim 1,
wherein the module further includes a first lens held on the third surface of the second substrate and not held on the second surface of the first substrate; and
wherein the first lens is disposed at a position through which the axis of the light to be used for the optical connection passes.

13. The optical module according to claim 12,
wherein the lens is fastened with light transmission resin, formed directly on the second substrate with light transmission resin, or formed by forming the second substrate.

14. The optical module according to claim 1,
wherein the optical element is a light receiving element;
wherein a transimpedance amplifier is provided on the second surface of the first substrate; and
wherein the transimpedance amplifier is disposed between the through-via hole and the light receiving element.

15. The optical module according to claim 1,
wherein the flip-chip bonding method is used to mount the light element on the second surface of the first substrate.

16. An optical module, comprising:
a package in which a fiber, a ferrule, a first lens, a first wavelength selection filter, a second wavelength selection filter; and
a first substrate, a second lens, a second substrate on which an optical element is mounted, and a pin are fastened respectively,
wherein the module further includes a first optical system, a second optical system, and a third optical system;
wherein the first optical system includes the fiber, the ferrule, and the first lens;
wherein the fiber, the ferrule, and the first lens are fastened in this order or in the reverse order in the package so as to be connected optically to the wavelength selection filter of the second optical system;
wherein the second optical system includes a first wavelength selection filter and a second wavelength selection filter;
wherein the first and second wavelength selection filters are fastened in the package so that a light reflected from the first wavelength selection filter is connected optically to the second wavelength selection filter;
wherein the third optical system includes a first substrate, a second lens, and a second substrate;
wherein the first substrate, the second lens, and the second substrate are fastened in the package so that the wavelength selection filter, the first substrate, and the second lens are connected optically to the optical element mounted on the second substrate in this order or in the reverse order.
wherein the module further includes a plurality of the third optical systems;
wherein one of the plural third optical systems is connected optically to the first wavelength selection filter; and
wherein the other two third optical systems are connected optically to the second wavelength selection filter.

17. The optical module according to claim 16,
wherein the second optical system includes a mirror; and
wherein this mirror is used to connect the first and second wavelength selection filters to each other optically.

18. The optical module according to claim 16,
wherein the first substrate of one of the three third optical systems is the same as the first substrate of each of the other two third optical systems;
wherein the second substrate of one of the three third optical systems is the same as the second substrate of each of the other two third optical systems; or
wherein the first substrate of one of the three third optical systems is the same as the first substrate of each of the other two third optical systems and the second substrate of one of the three third optical systems is the same as the second substrate of each the other two third optical systems.

19. The optical module according to claim 16,
wherein the fiber and the ferrule are replaced with a receptacle.

20. The optical module according to claim 16,
wherein the number of wavelength selection filters included in the second optical system is the same as the number of the mirrors included in the second optical system, plus one, or minus one.
